(19) United States
(12) Patent Application Publication
(10) Pub. No.: US 2007/0218794 A1
(43) Pub. Date: Sep. 20, 2007

(54) Ceiling member for vehicles

(75) Inventors: Tsutomu Nishida, Kayotoshi (JP); Fumi Takakura, Namerikawashi (JP); Toshinori Habe, Kashimagun (JP)

Correspondence Address: KRATZ, QUINTOS & HANSON, LLP, 1420 K Street, N.W., Suite 400, WASHINGTON, DC, 20005, US

(73) Assignee: SUMINOE TEXTILE CO., LTD, Osakashi (JP)

(21) Appl. No.: 11/376,569

(22) Filed: Mar. 16, 2006

(51) Int. Cl. B32B 5/18; B32B 5/02; D04B 21/00; D04B 1/22; B32B 5/26; D04H 13/00; B32B 5/24; D04B 7/00; D04H 5/00; D04B 9/00; B32B 27/12; D04B 11/00; D04H 3/00

(52) U.S. Cl. 442/315; 442/319; 442/312; 442/327; 442/304; 442/85; 442/370

(57) ABSTRACT

A ceiling member for vehicles according to the present invention includes a base material layer, and a surface skin material layer laminated on the base material layer. The surface skin material layer is a fabric made of a woven fabric or a knitted fabric, the fabric having a raised portion formed by raising a rear surface thereof, and the raised portion is directly bonded to the base material layer. Thus, a ceiling member for vehicles light in weight and enhanced in recycling efficiency can be provided while eliminating a bonding step using urethane.

### BACKGROUND OF THE INVENTION

1. Field of the Invention

The present invention relates to a ceiling member for vehicles, such as, e.g., automobiles or railway vehicles, and some preferred embodiments relates to a soft and cushioned ceiling member light in weight and excellent in sound absorbency.

2. Description of the Related Art

The following description sets forth the inventor's knowledge of related art and problems therein and should not be construed as an admission of knowledge in the prior art.

As shown in FIG. 2, in most conventional ceiling members, a urethane layer 16 is disposed between a base material layer 12 made of a resin molded article or a corrugated board and a surface skin material layer 13 made of a fibrous woven fabric, a knitted fabric, a nonwoven fabric, etc. The urethane layer 16 gives cushioning characteristics, prevents occurrence of wrinkles and/or pockmarks on the surface of the surface skin material layer 13, and also prevents soaking of adhesive agent 15 into the surface skin material layer 13. Especially, in the case of using a tricot fabric as a surface skin material layer, a urethane layer 16 is typically disposed between the base material layer 12 and the surface skin material layer 13 to bond them since the unevenness of the base material layer 12 appears as pockmarks on the surface of the surface skin material layer 13 as it is if no urethane layer 16 is used.

As a nonwoven fabric for ceiling members high in rigidity, light in weight and excellent in sound absorbency, Japanese Unexamined Laid-open Patent Publication No. 2001-347587 discloses a nonwoven fabric having an adhesive-rich-layer formed by impregnating adhesive in the surface portion of the nonwoven fabric. Adhesive had never been used to give rigidity though it had been widely used to bond materials. However, the aforementioned adhesive can attain lightweight properties while giving high rigidity, eliminating an adhesive layer, and decreasing the binder amount of the nonwoven fabric.

On the other hand, Japanese Unexamined Laid-open Patent Publication No. H11-268596 discloses an automobile ceiling member high in recycling efficiency which can be manufactured without requiring troublesome bonding steps. In the ceiling member, polyester fibers are used as the common structural materials of the base material layer, the surface skin material layer and the adhesion layer, and a certain low melting nonwoven fabric is used as the adhesion layer. Through certain flattening processing, the ceiling member can be obtained.

Although the aforementioned related arts are directed to a ceiling member for, e.g., automobiles or railroad vehicles, they fail to disclose a ceiling member in which a surface skin material is directly bonded to a base material layer. In the case of directly bonding a surface skin material to a base material layer without intervening a urethane layer, the thickness of the ceiling member becomes insufficient, the cushioning characteristics become poor, the sound absorbency deteriorates, the unevenness of the base material layer appears on the surface skin material, resulting in an unsuitable ceiling member. Under the circumstances, such a direct bonding of a surface skin material to a base material layer has not been performed.

Thus, in a conventional ceiling member for vehicles, in order to prevent a surface skin material from getting wrinkles, prevent adhesive from soaking into the knitted loops or the weave patterns and give cushioning characteristics, it was essential to dispose a urethane layer between the surface skin material layer and the base material layer.

Especially, as discussed above, in the case of using a tricot surface skin material, it was difficult to eliminate a urethane layer since the unevenness of the base material layer generally appears as pockmarks on the surface of the surface skin material layer.

In view of the above problems inherent in a conventional ceiling member, the present inventors conducted a research and development in order to eliminate a urethane layer to enhance the recycling efficiency so as to provide a ceiling member light in weight and excellent in sound absorbency. As a result, the inventors found the fact that raising of a rear surface of a surface skin material, such as, e.g., a tricot surface layer material, to increase the thickness of the surface skin material into a certain thickness gives cushioning characteristics and air permeability, which in turn enables elimination of a urethane layer.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The preferred embodiments of the present invention can significantly improve upon existing methods and/or apparatuses.

Among other potential advantages, some embodiments can provide a ceiling member with no urethane layer enhanced in recycling efficiency, light in weight and excellent in sound absorbency.

According to a first aspect of the preferred embodiment of the present invention, a ceiling member for vehicles, comprises a base material layer, and a surface skin material layer laminated on the base material layer, wherein the surface skin material layer is a fabric made of a woven fabric or a knitted fabric, the fabric having a raised portion formed by raising a rear surface thereof, and wherein the raised portion is directly bonded to the base material layer.

The base material layer can be made of, e.g., aresin molded article or a corrugated board, and is required to have thermal insulation performance to prevent dew condensation to the ceiling and appropriate stiffness enabling an attachment to the ceiling. Since the surface skin material layer has a raised rear surface, soft touch feeling and volume feeling can be obtained. Furthermore, this enhances sound absorbency and enables direct bonding to the base material layer without intervening a urethane layer.

According to a second aspect of the preferred embodiment of the present invention, a thickness of the fabric constituting the surface skin material layer is 1.0 to 8.0 mm, and air permeability of the fabric is 5 to 150 cm³/cm²·sec.

In order to obtain soft touch feeling and volume feeling, the fabric is required to have a certain thickness. The thickness is preferably 1.0 to 8.0 mm. More preferably, the thickness is 2.0 to 6.0 mm. To enhance the sound absorbing effect which reduces noise in a vehicle, it is preferable that the air permeability is 5 to 150 cm³/cm²·sec, more preferably 5 to 50 cm³/cm²·sec. It is especially preferable that the air permeability falls within the range of from 30 to 50 cm³/cm²·sec.

According to a third aspect of the preferred embodiment of the present invention, fibers constituting the raised portion include a thin fiber having a thickness of not less than 0.5 decitex but less than 5 decitex and a thick fiber having a thickness of not less than 5 decitex but not more than 20 decitex, and a constituent ratio of the thin fibers to the thick fibers is 30:70 to 70:30.

When fibers constituting the raised portion are a combination of thick fibers and thin fibers, the upper layer of the raised portion becomes rich in thin fibers and the lower layer becomes rich in thick fibers, which enables efficient sound absorbency and enhances the cushioning characteristics. The constituent ratio of thin fibers to thick fibers is preferably 30:70to70:30. The constituent ratio can be attained by combining thin fibers and thick fibers in accordance with the required cushioning characteristics and sound absorbing characteristics. Furthermore, depending on frequency of sound to be absorbed, it is possible to combine three or more types of fibers different in thickness.

According to a fourth aspect of the preferred embodiment of the present invention, the fabric constituting the surface skin material layer is a tricot knitted fabric. A tricot knitted fabric is good in elasticity, rich in soft touch feeling and volume feeling, right in weight, excellent in sound absorbency, and therefore it can be preferably used as a fabric for ceiling member.

The tricot knitted fabric can be a combination of various knit textures, yarns, etc., but not specifically limited.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a schematic cross-sectional view showing a ceiling member for vehicles according to an embodiment of the present invention;

FIG. 2 a schematic cross-sectional view showing a conventional ceiling member for vehicles; and

FIG. 3 shows an example of a knit structure of a surface skin material of a ceiling member for vehicles.

### DETAILED DESCRIPTION OF THE PREFERRED EMBODIMENTS

In the following paragraphs, a ceiling member for vehicles, such as, e.g.,automobiles or railroad vehicles, according to a preferred embodiment of the invention will be described by way of example and not limitation. It should be understood based on this disclosure that various other modifications can be made by those in the art based on these illustrated embodiments.

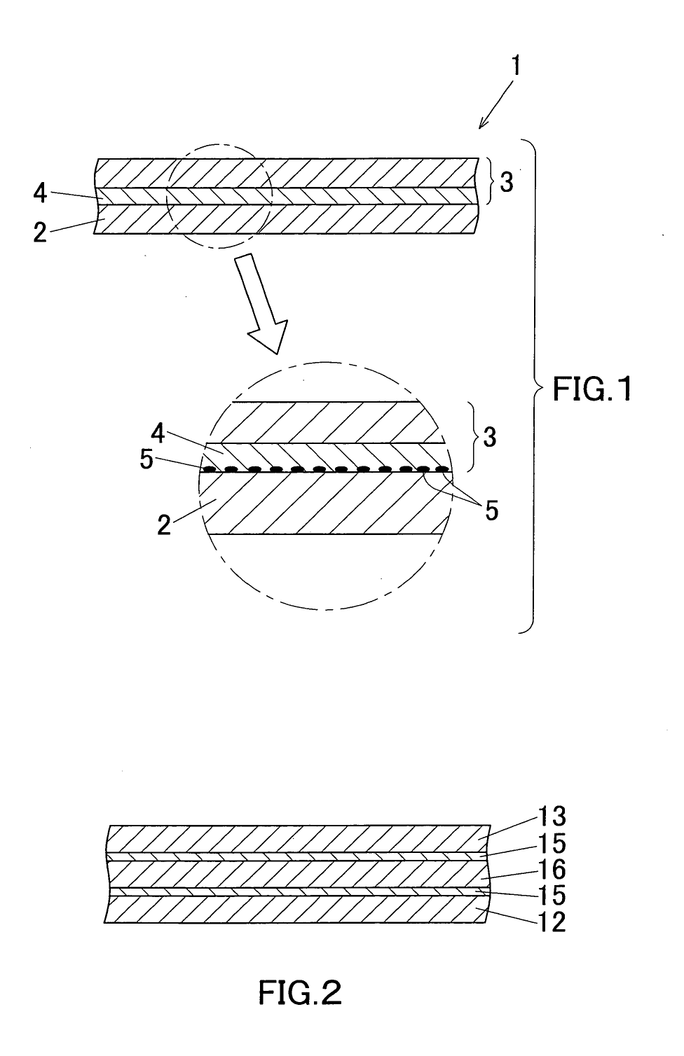

FIG. 1 is a schematic cross-sectional view showing a ceiling member for automobiles according to an embodiment of the present invention together with a partially enlarged view. In FIG. 1, the ceiling member for use automobiles is constituted by a base material layer 2 and a surface skin material layer 3. The base material layer 2 is a resin molded article, and the surface skin material layer 3 is a tricot fabric with a raised portion 4 formed by raising the rear surface thereof.

The surface of the tricot fabric is not specifically limited. It is preferable, however, that the rear surface thereof has 3 and 1 lapping structure to 12 and 1 lapping structure to enhance the raising of the rear surface. The thickness of the fabric is preferably set to 1.0 to 8.0 mm, and can be adjusted by the number of needle deflections, the number of yarns, raising conditions, etc.

If the fibers constituting the raised portion 4 is formed by a combination of a thick fiber group consisting of a fiber not less than 5 decitex but not more than 20 decitex in size and a thin fiber group consisting of a fiber not less than 0.5 decitex but less than 5 decitex in size, the thin fiber group becomes rich at the upper layer of the raised portion 4 and the thick fiber group becomes rich at the lower layer thereof, resulting in enhanced sound absorbency and cushioning characteristics. Furthermore, the use of crimped threads as the thick fiber group can further increase the cushioning characteristics.

The raising method is not specifically limited. The raising can be generally performed by a method using a card clothing and fibers will be cut by shirring to flatten the surface after the raising.

In this embodiment, hot-melt adhesive is used to bond the base material layer 2 and the surface skin material layer 3. The hot-melt adhesive can be polyolefin series resin, such as, e.g., polyethylene, polypropylene, ethylene-vinyl acetate copolymer, ethylene-ethyl acrylate copolymer, its modified polyolefin series resin, or a mixture of two or more of the aforementioned resin. The adhesive is can be preferably used as sheet-like resin or powder-like resin. Especially in cases where air permeability is required, hot-melt adhesive powder can be directly dispersed onto a surface skin material layer or a base skin material layer for a ceiling member. Alternatively, hot-melt adhesive powder dispersion liquid can be sprayed using a spray nozzle.

Next, the surface skin material layer 3 and the base material layer 2 are superimposed via the adhesive applied to the surface skin layer 3 and/or the base material layer 2. Then, both of them are hot-pressed at a temperature higher than the softening point of the hot-melt adhesive to obtain a ceiling member. Alternatively, after heating the surface skin material layer 3 or the base material layer 2 to which the adhesive was applied at the aforementioned temperature to soften the hot-melt adhesive, the surface skin material layer 3 and the base material layer 2 are superimposed and then cold-pressed to obtain a ceiling material.

As shown in the partially enlarged view of FIG. 1, the impregnation depth of the adhesive 5 into the raised portion 4 is preferably set to ⅓ to ⅔ of the thickness of the raised portion 4. If it is less than ⅓, the adhesive force becomes insufficient, which may cause detachment of the layers 2 and 3. On the other hand, if it exceeds ⅔, the cushioning characteristics deteriorate.

As the fibers constituting the tricot knitted fabric, natural fibers or synthetic fibers can be used. From the viewpoint of raising ability and recycling characteristics, synthetic fibers, such as, e.g., polyester or polypropylene can be more preferably used. From the viewpoint of sound absorbency, it is preferable that the thickness of the fiber falls within the range of from 3 to 80 μm. In general, there is such a tendency that thinner fibers enhance the sound absorbency and thicker fibers deteriorate the sound absorbency. Accordingly, it is preferable to select fibers falling within the aforementioned range.

The air permeability of the tricot fabric preferably falls within the range of from 5 to 150 cm³/cm²·sec. If the air permeability as the surface skin material 3 of a ceiling member for vehicles is 5 cm³/cm²·sec or below, the sound absorbency is poor and therefore it is not preferable. On the other hand, if it exceeds 150 cm³/cm²·sec, noise will pass through without being absorbed and then will be reflected by the base material layer 2 to be returned to the vehicle inner space. It is more preferable that the air permeability falls within the range of from 5 to 50 cm³/cm²·sec, still more preferably 30 to 50 cm³/cm²·sec.

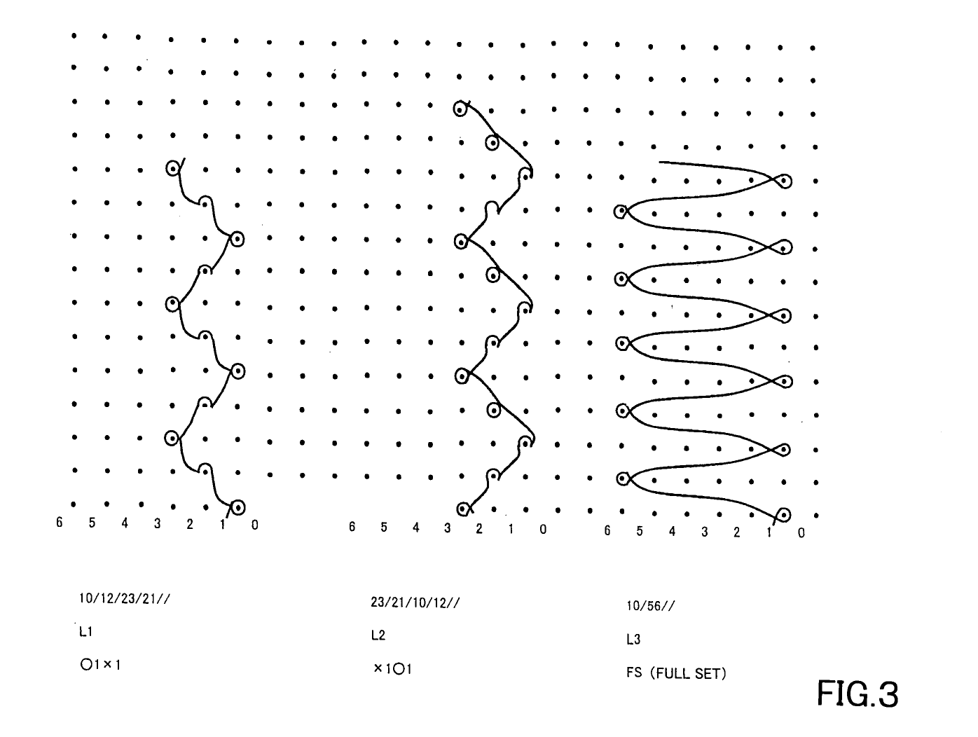

The texture of the tricot knitted fabric is preferably an easy-to-be-raised knitted texture as shown in, e.g., FIG. 3.

### EXAMPLE

Now, the present invention will be detailed with reference to examples. In these examples, the characteristic values were measured as follows.

(1) Thickness

The thickness was measured with a dial gauge at a constant load of 0.78N.

(2) Air permeability

The air permeability was measured by JIS-L-1096 8.27.1 A method. This is a method to be performed as follows. That is, 5 pieces of test pieces of about 20 cm×about 20 cm are obtained from different portions of a sample. Using a Frazier type air permeability tester, after attaching a test piece to an end of a cylinder, a suction fan is adjusted by a rheostat so that an inclination type barometer indicates 125 Pa. In this state, the air amount passing through the test piece (cm³/cm²·sec) is obtained from the pressure shown by a vertical type barometer and the type of the used air passage with reference to a table attached to the tester. This measurement will be repeated 5 times, and the average shows the air permeability.

(3) Soft touch feeling

This soft touch feeling is voluptuously evaluated. After touching a test sample manufactured into the shape of a ceiling for vehicles, it was evaluated by five-grade evaluation in which a sample having the best suitable soft touch feeling was graded as “Class 5,” and a sample which was only a base material layer to which no surface skin layer was bonded was graded as “Class 1.” Samples graded as “Class 4” and above were regarded as acceptable product.

(4) Appearance

Appearance of a test sample manufactured into the shape of a ceiling for vehicles was visually evaluated. It was evaluated by five-grade evaluation in which a sample having the best suitable appearance with no influence of the base material layer and no wrinkle was graded as “Class 5,” and a sample having the worst appearance with unevenness by wrinkles was graded as “Class 1.” Samples graded as “Class 4” and above were regarded as acceptable product.

### Example 1

Using a tricot knitting machine equipped with three reeds having 28 gauges, 110 decitex/48f polyester yarns (no heat treatment is conducted) were loaded to reeds L1 ·L2 in a 1-in-1-out manner and 1 and 1 lapping open loop and closed loop were alternatively loaded to the reeds to thereby obtain a surface texture. 84 decitex/36f polyester heater finished yarn were loaded to a reed L3 in a full-set manner to obtain a raising surface with 5 and 1 lapping closed loops. The knitted loop density was set to 60 coarse/2.54 cm, dyeing of 130° C.×60 minutes using gray disperse dye was executed with a liquid flow dyeing machine. After the drying, raising oil agent treatment was executed and then the rear surface was raised with a card clothing raising machine. The surface was flattened by shirring and tentering treatment was executed. Thus, a surface skin material was obtained. The weight was 266 g/m², the thickness was 3.75 mm, and the air permeability was 41 cm³/cm²·sec as shown in Table 1.

Then, on the raised rear surface of this fabric (surface skin material layer), polyethylene powder resin adhesive was dispersed at a rate of 80 g/m². Immediately after heating at 220° C. for 1 minute, the fabric was turned over and disposed on a base material layer of a resin foam molded article to bond them. Thus, a ceiling member for vehicles was obtained. After cutting into a shape of a ceiling member, it was evaluated. The evaluation was that it had soft touch feeling, rich volume feeling and excellent appearance. The evaluation grade of the soft touch feeling and appearance are also shown in Table 1.

### Example 2

A ceiling member for vehicles was obtained in the same manner as in Example 1 except that 4 and 1 lapping was used in place of 5 and 1 lapping. The weight was 220 g/m², the thickness was 2.75 mm, and the air permeability was 65 cm³/cm²·sec. as shown in Table 1. A satisfactory ceiling member for vehicles was obtained though the cushioning characteristics were not as good as the ceiling member of Example 1. The evaluation grade of the soft touch feeling and appearance are also shown in Table 1.

### Example 3

A ceiling member for vehicles was obtained in the same manner as in Example 1 except that 126 decitex/36f polyester heater finished yarn was used in place of the 84 decitex/36f polyester heater finished yarn. The weight was 305 g/m², the thickness was 3.5 mm, and the air permeability was 35 cm3/cm²·sec as shown in Table 1. An expensive-looking soft ceiling member for vehicles having cushioning characteristics superior to Example 1 was obtained. The evaluation grade of the soft touch feeling and appearance are also shown in Table 1.

### Example 4

A ceiling member for vehicles was obtained in the same manner as in Example 1 except that 10 and 1 lapping was used in place of the 5 and 1 lapping. The weight of the fabric (surface skin material layer) was 460 g/m², the thickness was 4.8 mm, and the air permeability was 57 cm³/cm²·sec as shown in Table 1. A soft ceiling member for vehicles thicker than the ceiling member of Example 1 and excellent in cushioning characteristics and sound absorbency was obtained. The evaluation grade of the soft touch feeling and appearance are also shown in Table 1.

### Example 5

Using a tricot knitting machine equipped with 4 reeds having 28 gauges, 84 decitex/36f polyester yarns (no heat treatment is conducted) were loaded to reeds L1·L2 in a 1-in-1-out manner and 1 and 1 lapping open loop and closed loop were alternatively loaded to the reeds to thereby obtain a surface texture. 84 decitex/36f polyester heater finished yarns were loaded to a reed L3 in a 1-in-1-out manner and 250 decitex/72f polyester heater finished yarns were loaded to a reed L4 in a 1-in-1-out manner to obtain a raising surface with 5 and 1 lapping closed loops. The knitted loop density was set to 40 coarse/2.54 cm, dyeing of 130° C.×60 minutes using gray disperse dye was executed with a liquid flow dyeing machine. After the drying, raising oil agent treatment was executed and then the rear surface was raised with a card clothing raising machine. The surface was flattened by shirring and tentering treatment was executed. Thus, a surface skin material was obtained. The weight was 420 g/m², the thickness was 4.2 mm, and the air permeability was 38 cm³/cm²·sec as shown in Table 1.

Then, in the same manner as in Example 1, on the raised rear surface of this fabric (surface skin material layer), polyethylene powder resin adhesive was dispersed at a rate of 80 g/m². Immediately after heating at 220° C. for 1 minute, the fabric was turned over and disposed on a base material layer of a resin foam molded article to bond them. Thus, a ceiling member for vehicles was obtained. The evaluation grade of the soft touch feeling and appearance are also shown in Table 1.

### Example 6

A ceiling member for vehicles was obtained in the same manner as in Example 1 except that 74 decitex/36f polypropylene heater finished spin-dyeing yarn was used in place of the 84 decitex/36f polyester heater finished yarn (no dyeing was executed). The weight of the fabric (surface skin material layer) was 246 g/m², the thickness was 3.5 mm, and the air permeability was 45 cm³/cm²·sec as shown in Table 1. An expensive-looking soft ceiling member for vehicles excellent in cushioning characteristics like Example 1 was obtained. The evaluation grade of the soft touch feeling and appearance are also shown in Table 1.

### Comparative Example 1

A ceiling member for vehicles was obtained in the same manner as in Example 1 except that the surface skin material layer was directly bonded to the base material layer without raising the rear surface of the surface skin material fabric. The weight was 266 g/m², the thickness was 1.1 mm, and the air permeability was 203 cm³/cm²·sec as shown in Table 1. This ceiling member was unsatisfactory in terms of soft touch feeling, volume feeling, and appearance. The evaluation grade of the soft touch feeling and appearance are also shown in Table 1.

### Comparative Example 2

A ceiling member for vehicles was obtained in the same manner as in Example 1 except that 40 decitex/16f polyester heater finished yarn was used in place of the 84 decitex/36f polyester heater finished yarn. The weight was 140 g/m², the thickness was 3.75 mm, and the air permeability was 180 cm³/cm²·sec as shown in Table 1. This ceiling member was poor in sound absorbency and lacks cushioning characteristics. The evaluation grade of the soft touch feeling and appearance are also shown in Table 1.

### Comparative Example 3

A ceiling member for vehicles was obtained in the same manner as in Example 1 except that 2 and 1 lapping was used in place of the 5 and 1 lapping. The weight of the fabric (surface skin material layer) was 106 g/m², the thickness was 1.8 mm, and the air permeability was 230 cm³/cm²·sec as shown in Table 1. This ceiling member was poor in soft feeling. The evaluation grade of the soft touch feeling and appearance are also shown in Table 1.

### Comparative Example 4

A ceiling member for vehicles was obtain by bonding the surface skin material fabric obtained in Example 1 to the base material layer with the non-raised surface of the fabric facing the base material layer. The weight of the fabric (surface skin material layer) was 266 g/m², the thickness was 3.75 mm, and the air permeability was 41 cm³/cm²·sec as shown in Table 1. This ceiling member felt hard and lacked cushioning characteristics. The evaluation grade of the soft touch feeling and appearance are also shown in Table 1.

TABLE 1

| | | | | | | | Comp. | Comp. | Com. | Comp. |
|---|---|---|---|---|---|---|---|---|---|---|
| | Example 1 | Example 2 | Example 3 | Example 4 | Example 5 | Example 6 | Example 1 | Example 2 | Example 3 | Example 4 |
| Raising yarn | Polyester | Polyester | Polyester | Polyester | Polyester | Polypropylene | Polyester | Polyester | Polyester | Polyester |
| | 84decitex/ | 84decitex/ | 126decitex/ | 84decitex/ | 84decitex/ | 74decitex/36f | 84decitex/ | 40decitex/ | 84decitex/ | 84decitex/ |
| | 36f | 36f | 36f | 36f | 36f | | 36f | 16f | 36f | 36f |
| | | | | | Polyester | | | | | |
| | | | | | 250decitex/ | | | | | |
| | | | | | 72f | | | | | |
| Number of | 5 | 4 | 5 | 10 | 5 | 5 | 5 | 5 | 2 | 5 |
| lapping | | | | | | | (not raised) | | | (bonded in a |
| | | | | | | | | | | reversed |
| | | | | | | | | | | state) |
| Thickness | 3.75 | 2.75 | 3.5 | 4.8 | 4.2 | 3.5 | 1.1 | 3.75 | 1.8 | 3.75 |
| (mm) | | | | | | | | | | |
| Weight | 266 | 220 | 305 | 460 | 420 | 246 | 266 | 140 | 106 | 266 |
| (g/m²) | | | | | | | | | | |
| Air | 41 | 65 | 35 | 57 | 38 | 45 | 203 | 180 | 230 | 41 |
| permeability | | | | | | | | | | |
| (cm³/cm² · sec) | | | | | | | | | | |
| Soft touch | 4 | 4 | 5 | 5 | 5 | 4 | 2 | 3 | 2 | 3 |
| feeling | | | | | | | | | | |
| Appearance | 5 | 4 | 5 | 5 | 5 | 5 | 2 | 4 | 3 | 4 |

In the embodiment of the present invention, raising of the rear surface of the fabric constituting the surface skin material causes cushioning characteristics and volume feeling. Therefore, the direct bonding of the fabric to various base material enables elimination of a cushioning material such as urethane which was used to be disposed between the fabric and the base material. Thus, the ceiling member can be widely used as a soft expensive-looking ceiling member for vehicles utilizing the characteristics of the fabric.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example;“and “NB” which means “note well.”

What is claimed is:

1. A ceiling member for vehicles, comprising:
a base material layer; and
a surface skin material layer laminated on the base material layer,
wherein the surface skin material layer is a fabric made of a woven fabric or a knitted fabric, the fabric having a raised portion formed by raising a rear surface thereof, and
wherein the raised portion is directly bonded to the base material layer.

2. The ceiling member for vehicles as recited in claim 1, wherein a thickness of the fabric constituting the surface skin material layer is 1.0 to 8.0 mm, and air permeability of the fabric is 5 to 150 cm³/cm² sec.

3. The ceiling member for vehicles as recited in claim 1, wherein fibers constituting the raised portion include a thin fiber having a thickness of not less than 0.5 decitex but less than 5 decitex and a thick fiber having a thickness of not less than 5 decitex but not more than 20 decitex, and a constituent ratio of the thin fibers to the thick fibers is 30:70 to 70:30.

4. The ceiling member for vehicles as recited in claim 1, wherein the fabric constituting the surface skin material layer is a tricot knitted fabric.

5. The ceiling member for vehicles as recited in claim 4, wherein a thickness of a yarn constituting the tricot knitted fabric is 3 to 80 μm.

6. The ceiling member for vehicles as recited in claim 1, wherein the raised portion is directly bonded to the base material layer with adhesive.

7. The ceiling member for vehicles as recited in claim 6, a permeation depth of the adhesive in the raised portion falls within the range of ⅓ to ⅔ of a height of the raised portion from a tip end of the raised portion.

8. A ceiling member for vehicles, comprising:
a base material layer; and
a surface skin material layer laminated on the base material layer,
wherein the surface skin material layer is a tricot knitted fabric having a thickness of 1.0 to 8.0 mm and air permeability of 5 to 150 cm³/cm²·sec, the fabric having a raised portion formed by raising a rear surface thereof, and
wherein the raised portion is directly bonded to the base material layer with adhesive.

9. The ceiling member for vehicles as recited in claim 8, wherein fibers constituting the raised portion include a thin fiber having a thickness of not less than 0.5 decitex but less than 5 decitex and a thick fiber having a thickness of not less than 5 decitex but not more than 20 decitex, and a constituent ratio of the thin fibers to the thick fibers is 30:70 to 70:30.

10. The ceiling member for vehicles as recited in claim 8, a permeation depth of the adhesive in the raised portion falls within the range of ⅓ to ⅔ of a height of the raised portion from a tip end of the raised portion.
